(19) United States
(12) Patent Application Publication
(10) Pub. No.: US 2009/0089106 A1
(43) Pub. Date: Apr. 2, 2009

(54) System And Method For Developing Strategic Scenario

(76) Inventors: Jeong-Seok Park, Daejon (KR); Kyung-Seok Ryu, Daejon (KR); Jee-Hyung Lee, Daejon (KR)

Correspondence Address: RABIN & Berdo, PC, 1101 14TH STREET, NW, SUITE 500, WASHINGTON, DC, 20005, US

(21) Appl. No.: 11/718,068

(22) PCT Filed: Oct. 27, 2005
(86) PCT No.: PCT/KR2005/003591

§ 371 Date: Jun. 3, 2008

(30) Foreign Application Priority Data
Nov. 1, 2004 (KR) 10-2004-0087901

(51) Int. Cl. G06Q 10/00; G06F 17/30; G06N 5/02

(52) U.S. Cl. 705/7; 707/104.1; 706/46; 707/E17.051; 707/E17.046; 707/E17.048

(57) ABSTRACT

Provided are a system and method for developing a strategic scenario. The system includes: a region analyzer for receiving initial scenario regions and sub-regions, verifying an organic relationships therebetween by performing a systematic thinking, calculating metric points of factors by performing an influencing matrix analysis, calculating a dynamic index for the factors based on the calculated metric points and classifying the factors into factor groups; a scenario diagnosis unit for selecting major factors based on the dynamic index and creating a projection catalogue of the selected major factors; a scenario developer for performing a comparability analysis between future prospects of selected major factors, performing a projection bundle extracting analysis based on the metric results from the comparability analysis, and deciding a final scenario by performing a cluster and a multidimensional scaling analysis; and a database for storing data generated from the region analyzer, the scenario diagnosis and the scenario developer.

### TECHNICAL FIELD

The present invention relates to development of a strategic scenario; and more particular, to a system and method for developing a strategic scenario.

### BACKGROUND ART

Planners and administrators of an enterprise establish a strategy to lead the enterprise by analyzing environmental factors and creating future scenarios based on the analysis result. In order to establish the strategy, a scenario analysis methodology has bee widely used.

However, the scenario analysis methodology has a drawback that a future strategic scenario may be too much influenced by subjective opinions of planners or the administrators because many decisions are made and environmental factors are selected based on the subjective opinions of the planners or the administrators. Also, it is very difficult to confront diverse economical environment variations using the strategic scenario created by the conventional methodology. That is, the reality of the scenarios degrades, comparatively.

Also, the conventional scenario analysis methodology was not embodied through an information system, database of environmental factors was not provided, newly issued environmental factors are not reflected on the created scenarios, and the created scenarios was not modified or changed timely and appropriately.

In order to confront rapidly and unexpectedly changed business environments, database of essential and related environmental factors must be built through the information system to prevent developing steps of strategic scenarios from being repeatedly progressed and from being progressed without consistency.

It is because the conventional scenario analysis methodology generally uses a top-down approach.

Therefore, planners and administrators must select environmental factors through metrical analysis and create scenarios based on the metric results generated by the metrical analysis in order to create realistic strategic scenarios.

Also, realistic assumptions must to be managed, and database thereof must be built through the information system. Such a database makes it possible to update the database to confront variations of environmental factors and business environments, to accurately and rapidly modify and recreate scenarios and to compare and analyze the past business scenarios and the recreated or modified business scenarios. As a result, the business scenarios become more realistic.

### DISCLOSURE

### Technical Problem

It is, therefore, an object of the present invention to provide a strategic scenario developing system for rapidly, accurately and systematically developing a scenario and establishing business strategy by performing a systematic thinking and a metrical analysis through a bottom-up approach for selecting scenarios, building a database of factors and creating an automatic system for analyzing various factors, and a method thereof.

### Technical Solution

In accordance with one aspect of the present invention, there is provided a system for developing a strategic scenario including: a scenario region analyzing unit for receiving initial scenario regions and sub-regions from planners, verifying an organic relationships between the scenario region and the sub-regions by performing a systematic thinking, calculating metric points of factors influencing the scenario regions and the sub-regions by performing an influencing matrix analysis, calculating a dynamic index for the factors based on the calculated metric points and classifying the factors into factor groups; a scenario diagnosis unit for selecting major factors based on the dynamic index calculated at the scenario region analyzing unit and creating a projection catalogue of the selected major factors; a scenario developing unit for performing a comparability analysis on future prospects of selected major factors, performing a projection bundle extracting analysis based on the obtained metric results through the comparability analysis, and deciding a final scenario by performing a cluster analysis and a multidimensional scaling analysis on the extracted bundles; and a database for storing data generated at the scenario region analyzing unit, the scenario diagnosis unit and the scenario developing unit.

In accordance with another aspect of the present invention, there is provided a method of developing a strategic scenario including the steps of: a) performing a systematic thinking based on initial scenario regions and sub-regions selected by a planner; b) performing an influence matrix analysis on factors influencing the selected scenario regions and sub-regions and calculating metric points; c) calculating a dynamic index of the factors based on the calculated metric points and classifying the factors based on the calculated dynamic index; d) creating a projection catalogue of major factors selected based on the dynamic index; e) performing a comparability analysis based on future prospects of the major factors obtained through the creating the catalogue; f) performing a projection bundle extracting analysis based on the metric results obtained through the comparability analysis; and g) deciding final scenarios by performing a cluster analysis and a multidimensional analysis through the extracted bundles.

### ADVANTAGEOUS EFFECTS

The system and method according to present invention creates a scenario rapidly, accurately and systematically. Therefore, the system and method allows planners to actively create accurate scenarios to confront rapidly varying business environments.

The system and method for developing a scenario according to the present invention allows planners to easily update data and to simply modify the data. Therefore, the planner develops accurate scenario with less time.

### DESCRIPTION OF DRAWINGS

The above and other objects and features of the present invention will become apparent from the following description of the preferred embodiments given in conjunction with the accompanying drawings, in which:

FIG. 1 is a block diagram illustrating a system for developing strategic scenarios in accordance with a preferred embodiment of the present invention;

FIG. 2 is a table showing initial scenario regions and sub-regions stored in a database;

FIG. 3 shows a relationship model created through a systematic thinking and outputted on the web page in accordance with a preferred embodiment of the present invention;

FIGS. 4 and 5 show selected, confirmed and stored factors influencing a scenario;

FIG. 6 shows an influence matrix generated by performing an influence matrix analysis in accordance with a preferred embodiment of the present invention;

FIGS. 7 and 8 show classification of factors and dynamic index value thereof in accordance with a predetermined embodiment of the present invention;

FIG. 9 shows major factors selected based on the dynamic index value in accordance with a preferred embodiment of the present invention;

FIG. 10 shows a project catalog format in accordance with a preferred embodiment of the present invention;

FIG. 11 shows a result of compatibility analysis;

FIG. 12 shows a result of selected projection bundles;

FIG. 13 is a view for explaining the cluster analysis;

FIG. 14 is a view for describing the multidimensional scaling analysis; and

FIG. 15 is a flowchart of a method of developing a strategic scenario in accordance with a preferred embodiment of the present invention.

### BEST MODE FOR THE INVENTION

Other objects and aspects of the invention will become apparent from the following description of the embodiments with reference to the accompanying drawings, which is set forth hereinafter.

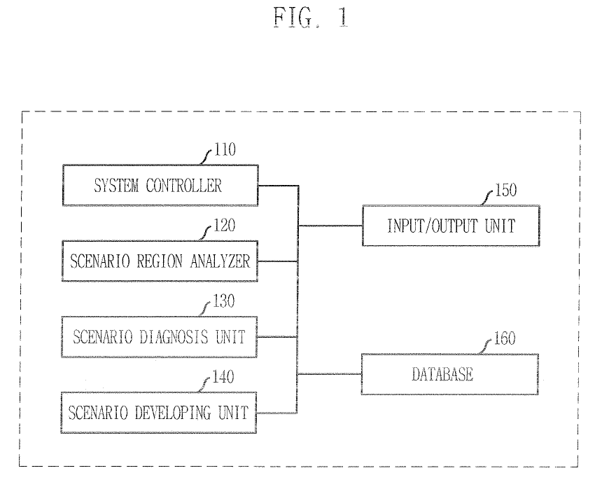

FIG. 1 is a block diagram illustrating a system for developing strategic scenarios in accordance with a preferred embodiment of the present invention.

As shown in FIG. 1, the strategic scenarios developing system according to the preset embodiment includes a system controller 110, a scenario region analyzer 120, a scenario diagnosis unit 130, a scenario developing unit 140, a database 150 and an input/output unit 150.

The system controller 110 generally controls each functional blocks of the system and provides various processed data to a user as forms of various web pages through the input/output unit 150. Herein, the web pages are created based on a hyper text markup lingual (HTML) or a Java script.

The scenario region analyzer 120 stores initial scenario regions and sub-regions created by planners into the database 150, performs a systematic thinking based on the created scenario regions and sub-regions, and verifies whether the scenario regions and the sub-region thereof are organically connected or not.

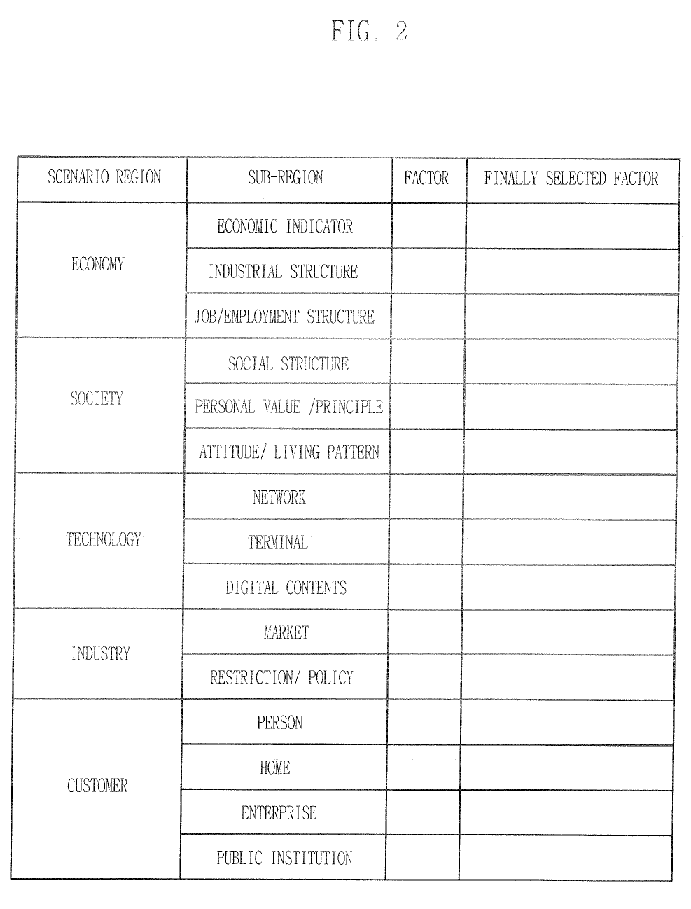

FIG. 2 is a table showing initial scenario regions and sub-regions stored in a database.

As shown in FIG. 2, the initial scenario regions may include an economy, a society, a technology, an industry, and a customer. Each of the scenario regions includes sub-regions. For example, the scenario region ‘economy’ includes sub-regions such as an economic indicator, an industrial structure and an occupation and employment structure. Also, the scenario region ‘society’ includes the sub-regions such as a social structure, a personal value/principle and an attitude/living pattern. As shown above, the initial scenario regions may be divided into various sub-regions according to the planners.

The initial scenario regions and the sub-regions are created and then relationships therebetween are defined through modeling. The creating and defining the relationship in the present embodiment is very similar to data modeling to define relationship between entities.

That is, a user inputs an active or a passive relationship between the scenario regions and the sub-regions thereof through the input/output unit 150 and then the scenario region analyzer 120 recognizes the inputted relationships therebetween, creates a relationship model and outputs the created relationship model through the web pages.

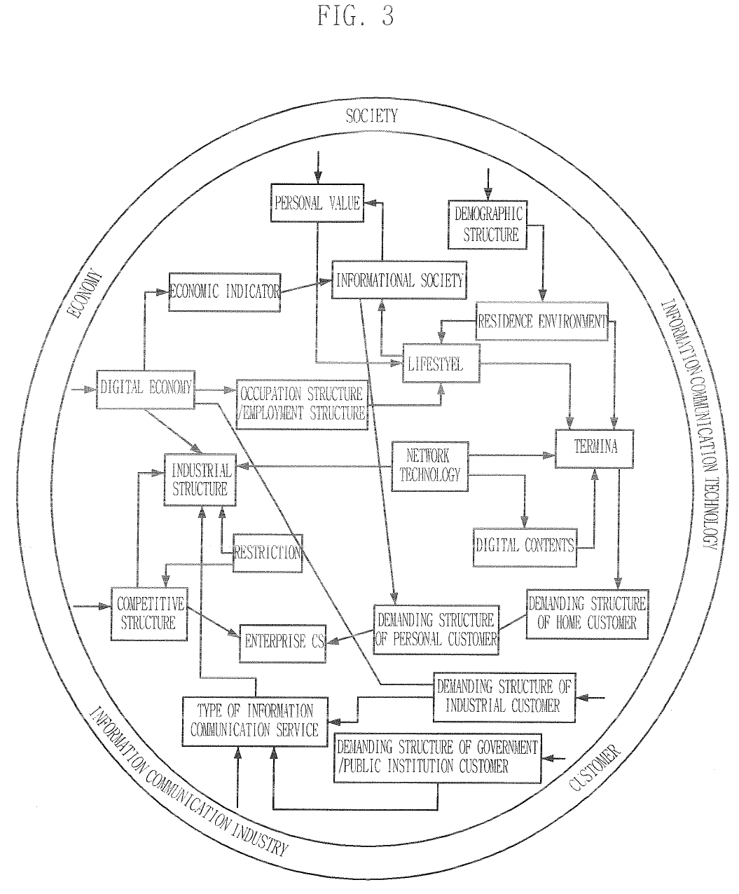

FIG. 3 shows a relationship model created through a systematic thinking and outputted on the web page in accordance with a preferred embodiment of the present invention. When the relationship model is created, an ambiguity relationship and an undefined relationship are deleted by the scenario region analyzer 120.

The planner selects and confirms factors influencing a scenario based on the scenario regions and the sub-regions thereof created through the systematic thinking and outputted on the web page using the input/output unit 150. That is, a planner selects most important factor among the given regions and confirms the selected region.

Herein, the selected region as the most influencing factor is stored in the database 150 through the scenario region analyzer 120 in order to allow the planner to update or delete smoothly and frequently.

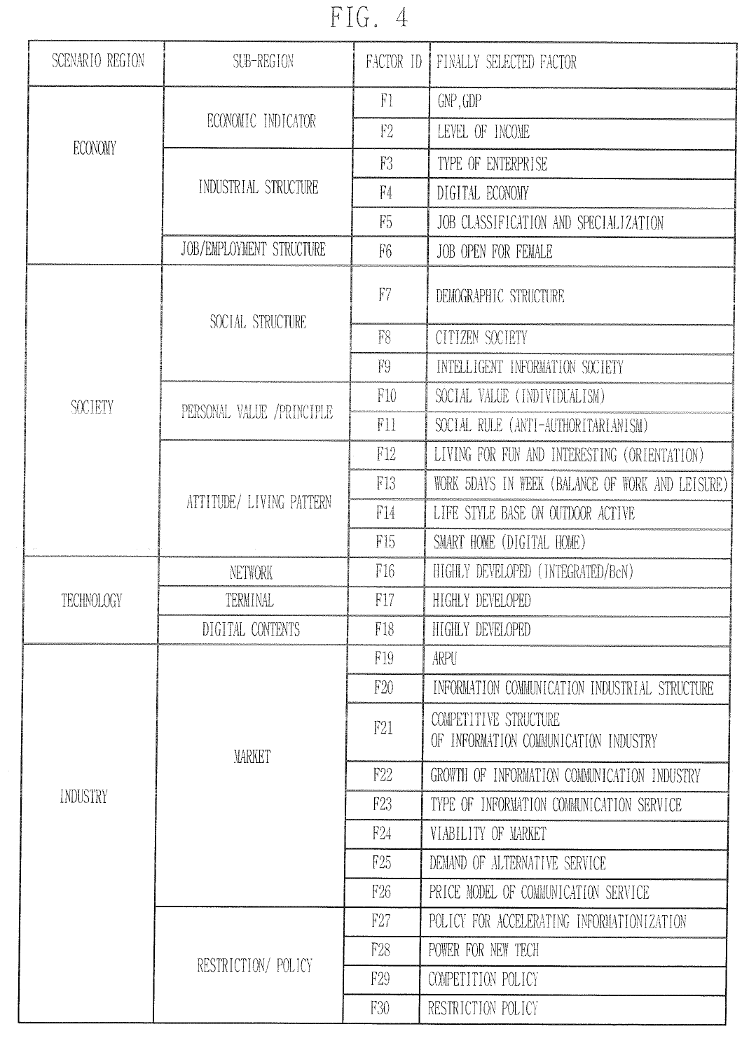

FIGS. 4 and 5 show selected, confirmed and stored factors influencing a scenario.

After selecting and storing the factors, the planner assigns a passive point and an active point to the selected factors through the input/output unit 150. The passive point denotes a level of influence received from other factors and the active point denotes a level of influence giving to other factors.

The scenario region analyzer 120 performs an influence matrix analysis based on the active point and the passive point and outputs the result of the analysis through the input/output unit 150. That is, the scenario region analyzer 120 adds the active points and the passive points. The sum of the active points and the sum of the passive points are used as a reference value to classify the factors into influence factor groups.

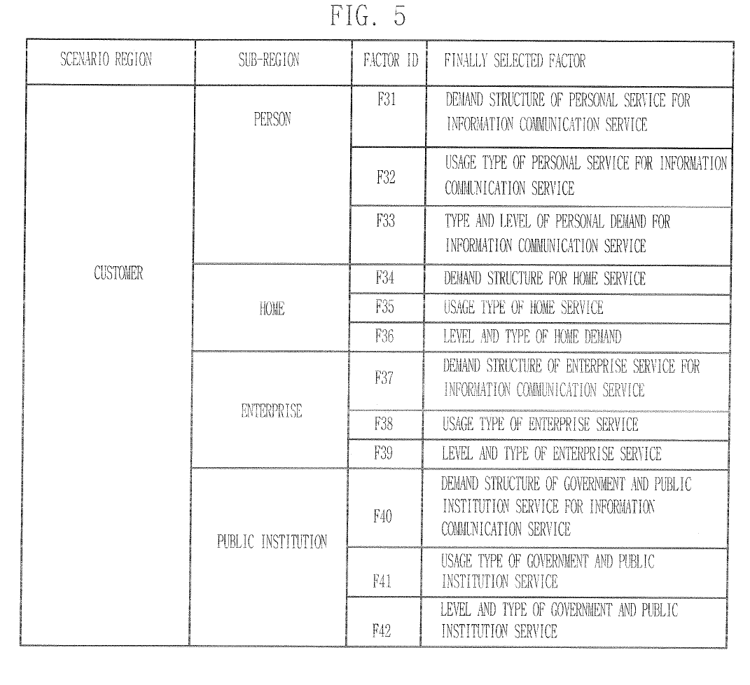

FIG. 6 shows an influence matrix generated by performing an influence matrix analysis in accordance with a preferred embodiment of the present invention.

As shown in FIG. 6, a right end column denotes the sums of the active points and a bottom end raw denotes the sums of the passive points.

In the present embodiment, the planner gives one of values in a range of 0 to 3 as the active point or the passive point, and the planer assigns the active points to each of factors and then, the passive points thereof are automatically assigned. However, assigning of the active point and the passive point may be modified various forms in other embodiments. For example, the planner may assign the passive points and then, the active points thereof may be automatically assigned.

The scenario region analyzer 120 classifies the factors into influencing factor groups based on the calculated active points and passive points through the influence matrix analysis. These influencing factor groups may be impulsive factors, dynamic factors, reactive factors and buffer factors.

Also, the scenario region analyzer 120 calculates a dynamic index by multiplying the active point and the passive point of each of the factors. Major influencing factors are defined and confirmed by selecting factors having a highest dynamic index value.

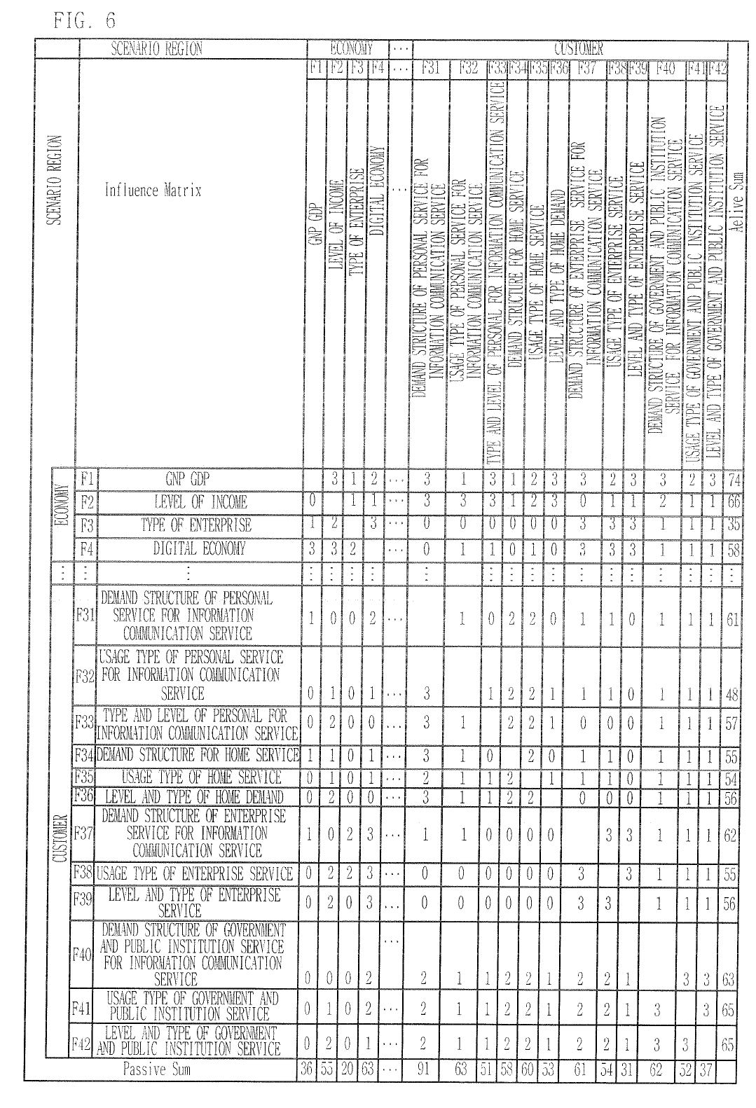

FIGS. 7 and 8 show classification of factors and dynamic index value thereof in accordance with a predetermined embodiment of the present invention. The right most column denotes the calculated dynamic indexes.

As shown in FIGS. 7 and 8, if a factor has both of an active point sum and a passive point sum larger than and equal to 60, the factor is classified into the dynamic factor group. If a factor has an active point sum larger than and equal to 60 and a passive point sum smaller than 60, the factor is classified into the impulsive factor group. If a factor has an active point sum smaller than 60 and a passive sum larger than and equal to 60, the factor is classified into the reactive factor group. If a factor has both of active point sum and passive point sum smaller than 60, the factor is classified into the impulsive factor group.

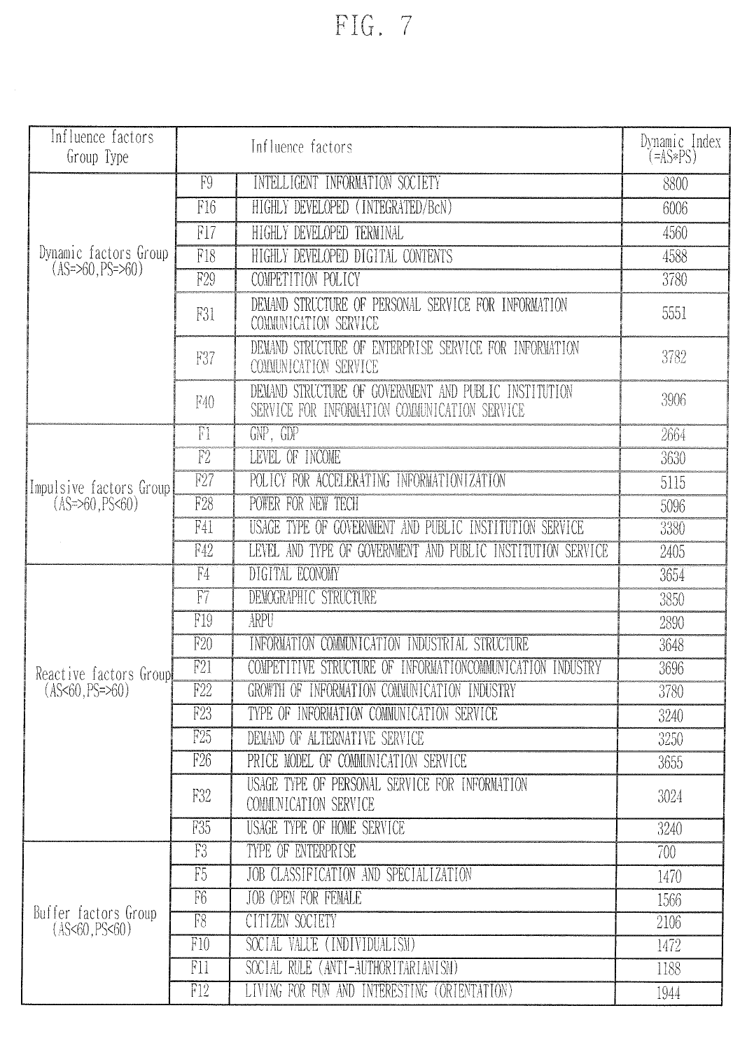

FIG. 9 shows major factors selected based on the dynamic index value in accordance with a preferred embodiment of the present invention.

The scenario diagnosis unit 130 provides a project catalogue format to the planner through the input/output unit 150 to create a catalog showing a current state and a future prospect of each of the selected and confirmed major factors. The planner creates the catalog through the input/output unit 150. Then, the scenario diagnosis unit 130 stores the created catalog into the database 150.

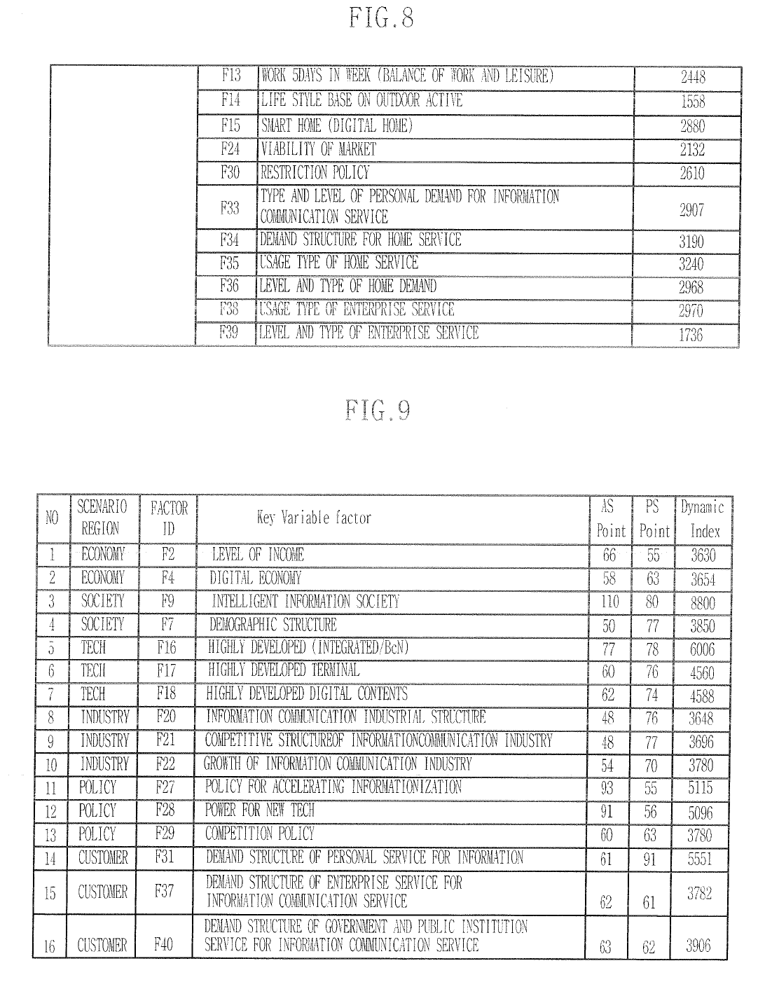

FIG. 10 shows a project catalog format in accordance with a preferred embodiment of the present invention.

In the present embodiment, the initial scenario region is an information communication technology and the influencing factor is highly-developed terminal. And, the current state and further prospect thereof are shown.

The scenario developing unit 140 analyzes compatibility between the future prospects of the major factors through metrical analysis. Then, the scenario developing unit 140 performs project bundle extraction and analysis based on the metrical results. Herein, the scenario developing unit 140 selects project bundles having highest values and outputs the selected project bundles through the input/output unit 150.

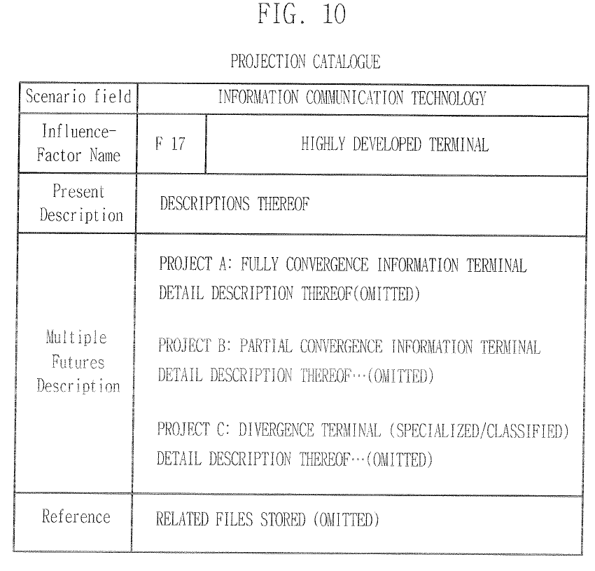

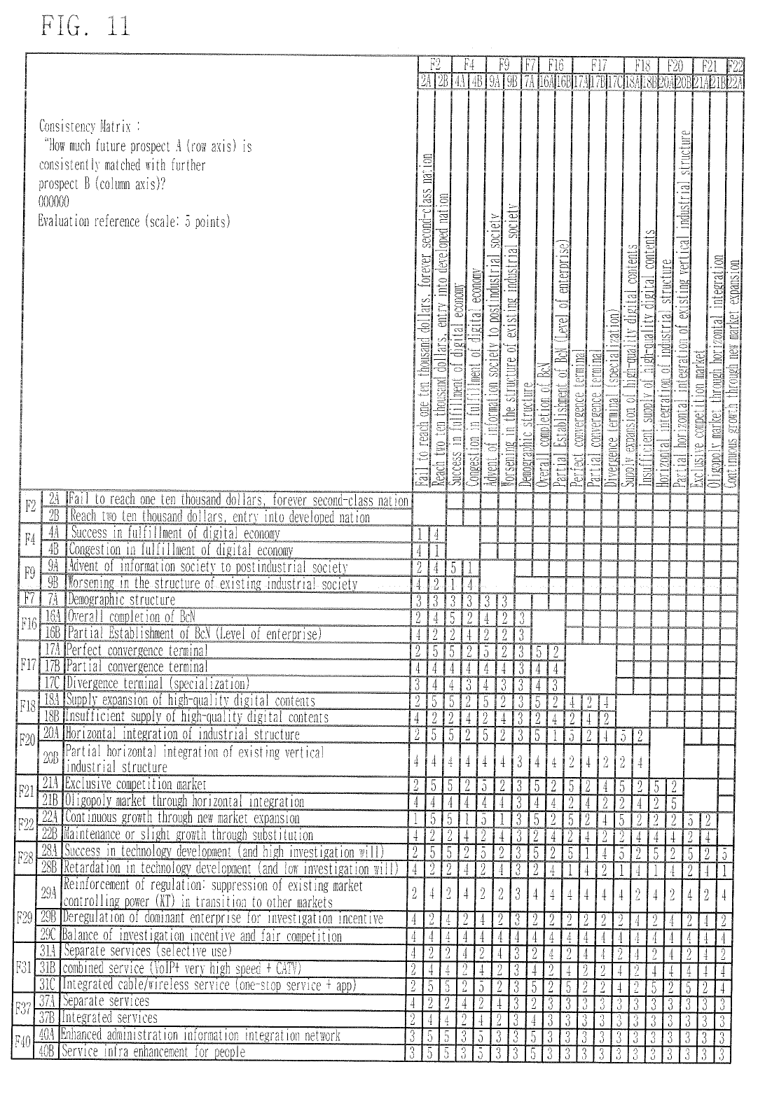

FIG. 11 shows a result of compatibility analysis, and FIG. 12 shows a result of selected projection bundles in accordance with a preferred embodiment of the present invention.

Based on the result of metrical results obtained through the compatibility analysis, the number of projection bundles is decided by the number of influencing factors. The number of projection bundles may be several thousands or hundred thousands. In the present embodiment, projection bundles having highest value are selected but projection bundles desired by the planner may be selected in other embodiments.

The scenario developing unit 140 decides realistic scenarios by a cluster analysis through selected bundles and a multidimensional scaling analysis and outputs the decided scenario through the input/output unit 150.

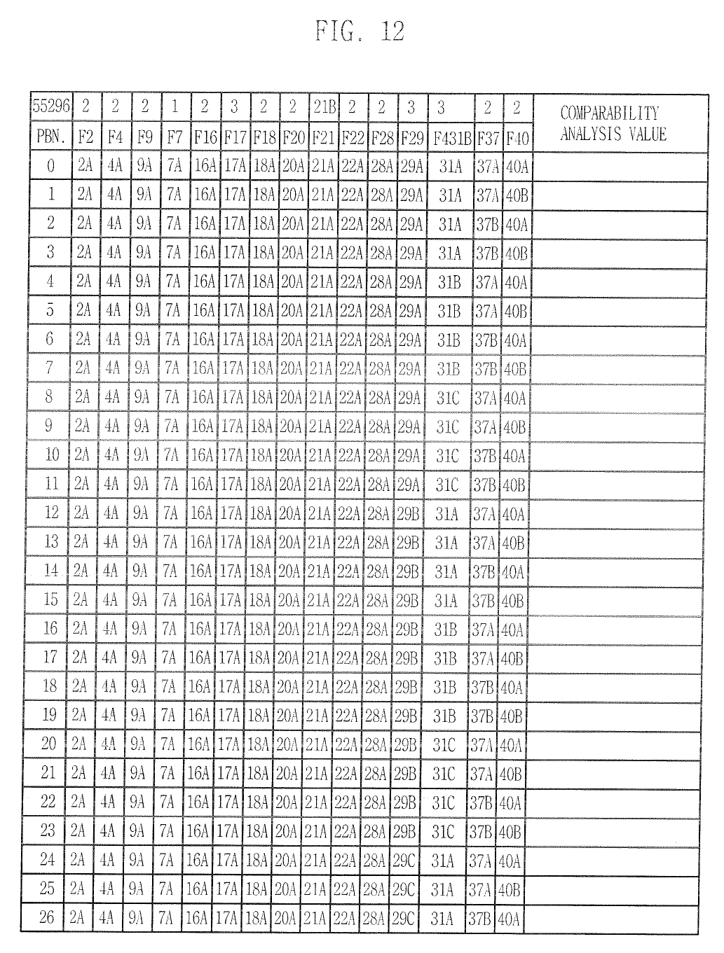

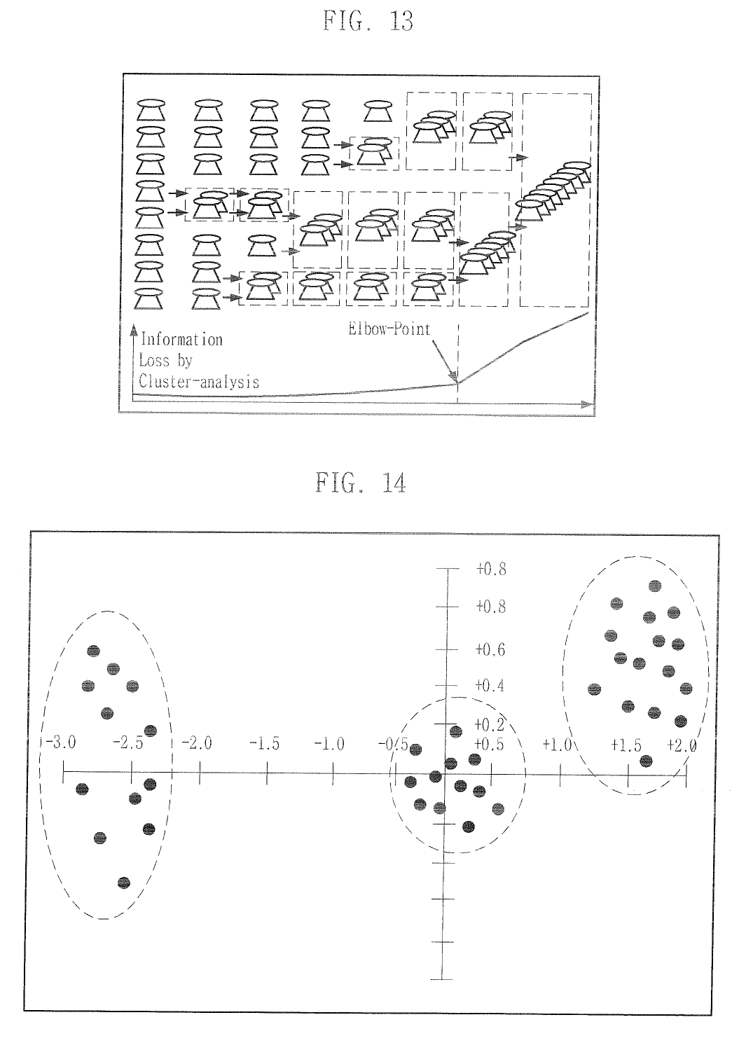

FIG. 13 is a view for explaining the cluster analysis and FIG. 14 is a view for describing the multidimensional scaling analysis.

As shown in FIG. 13, the scenario developing unit 140 decides a cluster form of projections in a bundle using a statistic program based on the metric analysis results of the selected projection bundles.

As shown in FIG. 14, the scenario developing unit 140 finally positions visual scenario based on a multidimensional reference to configure a scenario using the statistics program.

The planner extracts strategies per corresponding scenarios by applying principles of strategic administration based on the selected scenarios.

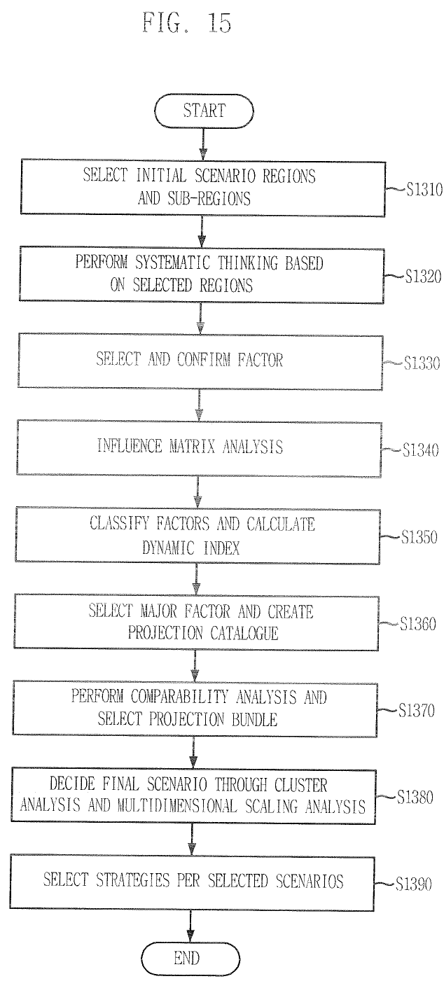

FIG. 15 is a flowchart of a method of developing a strategic scenario in accordance with a preferred embodiment of the present invention.

As shown in FIG. 15, an initial scenario region and sub-regions thereof are selected by a planner at step S1310.

Then, a systematic thinking is performed based on the selected initial scenario regions and sub-regions thereof at step S1320. At the step S1320, it determines whether the selected scenario regions and their sub-regions are organically related or not.

Then, factors are selected and confirmed based on the extracted scenario region and sub-regions thereof at step S1330.

After selecting the factors that influence developing of realistic scenario, an influence matrix analysis is performed on the selected factors at step S1340. That is, an active point and a passive point are assigned to the selected factors and an active point sum and a passive point sum are calculated.

Then, the factors are classified into an influencing factor groups based on the active point sum and the passive point sum at step S1350. That is, the factors are classified in to the impulsive factor group, the dynamic factor group, the reactive factor group and the buffer factor group, and the dynamic index is calculated by multiplying the active point sum and the passive point sum.

After classifying, major factors are selected and confirmed based on the dynamic index value and a projection catalogue of major factors is created at step S1360. The catalogue is stored as a database and persistently and freely modified and managed.

Then, the comparability analysis is performed based on major factors and future prospect obtained through creating the catalogue, and the projection bundles are extracted based on metric results obtained through the comparability analysis at step S1370.

After extracting, the cluster analysis and the multidimensional scaling analysis are performed and a final scenario is decided at step S1380.

Then, the strategies per decided scenarios are selected at step S1390.

While the present invention has been described with respect to certain preferred embodiments, it will be apparent to those skilled in the art that various changes and modifications may be made without departing from the scope of the invention as defined in the following claims.

What is claimed is:

1. A system for developing a strategic scenario comprising:
scenario region analyzing means for receiving initial scenario regions and sub-regions from planners, verifying an organic relationships between the scenario region and the sub-regions by performing a systematic thinking, calculating metric points of factors influencing the scenario regions and the sub-regions by performing an influencing matrix analysis, calculating a dynamic index for the factors based on the calculated metric points and classifying the factors into factor groups;
scenario diagnosis means for selecting major factors based on the dynamic index calculated at the scenario region analyzing means and creating a projection catalogue of the selected major factors;
scenario developing means for performing a comparability analysis on future prospects of selected major factors, performing a projection bundle extracting analysis based on the obtained metric results through the comparability analysis, and deciding a final scenario by performing a cluster analysis and a multidimensional scaling analysis on the extracted bundles; and
database for storing data generated at the scenario region analyzing means, the scenario diagnosis means and the scenario developing means.

2. The system as recited in claim 1, wherein the scenario region analyzing means calculates a passive point sum and an active point sum per each of the factors by performing the influence matrix analysis, classifies the factors into factor groups based on the calculated passive point sum and active point sum and calculates the dynamic index per each factor by multiplying the active point sum and the passive point sum.

3. The system as recited in claim 2, wherein the factor groups are impulsive factors, dynamic factors, reactive factors and buffer factors.

4. The system as recited in claim 3, wherein the comparability analysis expresses interoperability between future prospects as numeral values through performing a metric analysis on the future prospects of the major factors, and performs a matrix type analysis on the numeral values to output the result.

5. The system as recited in claim 4, wherein the projection bundles are selected by selecting projection bundles having highest values among all bundles based on the metric results obtained through the comparability analysis.

6. A method of developing a strategic scenario comprising the steps of:
a) performing a systematic thinking based on initial scenario regions and sub-regions selected by a planner;
b) performing an influence matrix analysis on factors influencing the selected scenario regions and sub-regions and calculating metric points;
c) calculating a dynamic index of the factors based on the calculated metric points and classifying the factors based on the calculated dynamic index;
d) creating a projection catalogue of major factors selected based on the dynamic index;
e) performing a comparability analysis based on future prospects of the major factors obtained through the creating the catalogue;
f) performing a projection bundle extracting analysis based on the metric results obtained through the comparability analysis; and
g) deciding final scenarios by performing a cluster analysis and a multidimensional analysis through the extracted bundles.

7. The method as recited in claim 6, wherein in the step b), a passive point sum and an active point sum are calculated per each factor.

8. The method as recited in claim 7, wherein in the step c), the factors are classified into factor groups based on the active point sum and the passive point sum and a dynamic index is calculated by multiplying the active point sum and the passive point sum.

9. The method as recited in claim 8, wherein the classified factor groups are impulsive factors, dynamic factors, reactive factors and buffer factors.

10. The method as recited in claim 9, wherein in the step e), interoperability between future prospects is expressed as numeral values through performing metric analysis on future prospects of major factors, and a matrix type analysis is performed based on the numeral values to output the result.

11. The method as recited in claim 10, wherein the step f), projection bundles having highest value are selected among all bundles based the obtained metric results through the comparability analysis.
